(19) United States
(12) Patent Application Publication
(10) Pub. No.: US 2005/0110218 A1
(43) Pub. Date: May 26, 2005

(54) Seal arrangement

(76) Inventors: Michael K. Morrison, Portishead (GB); Robert J. Baxendale, Coleorton (GB); Paul W. Ferra, Derby (GB)

Correspondence Address: MANELLI DENISON & SELTER, 2000 M STREET NW SUITE 700, WASHINGTON, DC, 20036-3307, US

(21) Appl. No.: 10/961,039

(22) Filed: Oct. 12, 2004

(30) Foreign Application Priority Data
Oct. 31, 2003 (GB) 0325441.4

(51) Int. Cl. F16J 15/34

(52) U.S. Cl. 277/358

(57) ABSTRACT

Seal arrangements are arranged to provide a seal edge suspended on suspension mountings to accommodate for axial movements in a component against which the edge acts. The edge is associated with a backing member so that the edge extended to a desired degree beyond the backing member to provide a good sealing function by suspending the edge it is allowed to float and so does not become excessively worn due to axial movements or excursions by the component 6, 36, 46, 56 whilst retaining the seal edge 4, 34, 44, 54 at an appropriate position for sealing efficiency. Typically, the seal edge is formed from bristles of a brush seal. A number of seal arrangements 1, 31, 41, 51 are normally arranged in a seal assembly 63.

The present invention relates to seal arrangements and more particularly to seal arrangements which incorporate a brush seal between a stationary mounting and a rotating component possibly in the form of a labyrinth type seal.

It is known to provide a seal arrangement which comprises a brush extending normally from a stationary mounting to a rotating component. Bristles of the brush engage through their tips the rotating component to provide the seal. A backing plate is provided in order to resist backward displacement of the bristles at high pressures.

It will be understood that rotating components by their nature can experience displacements from the desired or expected axis of rotation. Such displacements may cause excessive compressive contact between the bristles and the surface of the rotating component. Excessive compressive force will lead to rapid wear of the bristles and in particular the bristle tips. Nevertheless if the bristle are configured with a long free ends to accommodate such excursions then the seal arrangement will be relatively leaky whilst as indicated above too short free bristle ends will rapidly wear down to leave an ineffective seal.

Ideally, a seal arrangement should have a long life with predictable performance throughout that operational life.

In accordance with the present invention there is provided a seal arrangement for a rotating component, the arrangement comprising a seal edge with a backing member to provide a seal in use, the seal edge extending beyond the backing member, the arrangement characterised in that the seal edge is suspended upon a suspension mounting to control the extent by which the seal edge extends beyond the backing member.

Typically, the seal edge is provided by bristle tips from a seal brush. Possibly, the brush comprises bristles angled relative to the seal edge and in particular to a rotating surface to which it provides a seal in use.

Alternatively, the seal edge is provided by a seal apron of elastomeric material or leaf seal element.

Preferably, the suspension mounting comprises a bellows like concertina arrangement. Possibly, the suspension mounting comprises a coil or compression spring. Alternatively, the suspension mounting comprises a leaf spring. Additionally, it is possible the suspension mounting comprises a hydraulic or pneumatic spring. Generally, the seal edge is secured about on end of the suspension mounting.

Normally, the suspension mounting provides a seal bias force for the seal edge. Possibly, the seal bias force is altered to provide differing seal strengths for the seal arrangement.

Possibly, a stop member is provided in association with the backing member and/or the suspension mounting to prevent lateral displacement of the arrangement.

Advantageously, a secondary seal is provide to supplement the seal provide by the seal edge. Typically, the secondary seal is associated with the backing member. Possibly, the secondary seal is a compression ring between the backing member and a housing within which the arrangement is secured. Further advantageously the secondary seal is part of the stop member.

Generally, a plurality of seal arrangements as describe above will be associated together within a seal assembly for provision of a seal between two components. Normally, one of these components will be stationary whilst the other is a rotating component.

Possibly, there is a slide element presents a backing member towards a sealing surface with the sealing edge towards the sealing surface, the slide element is suspended through variations in pressure differential between an enclosure pressure and a seal cavity pressure as varied by leakage across the sealing edge towards an exterior pressure. Advantageously, the slide element is supported upon a slide surface with secondary seals there between. Possibly, the slide element is constrained to axial movement in order to present the seal edge similarly. Furthermore, said axial movement is limited by a stop element to prevent clash between the backing member and the seal surface. Normally, the seal cavity pressure is defined within a seal cavity configured by a seal fin adjacent a part of the slide element. Advantageously, the seal fin and/or the part are shaped to varying a clearance gap between that fin and part dependent upon actual position of the slide element.

Also in accordance with the present invention there is provided a turbine engine which incorporates a seal arrangement or seal assembly as described above.

Embodiments of the present invention will now be described by way of example only with reference to the accompanying drawings in which:

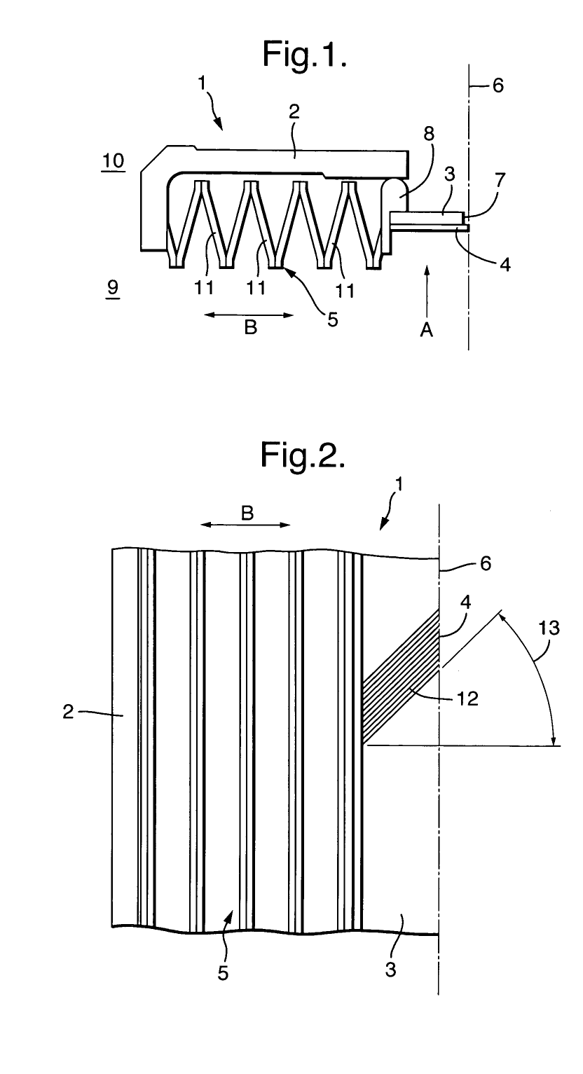

FIG. 1 is a schematic side illustration of a seal arrangement in accordance with a first embodiment of the invention;

FIG. 2 is a schematic plan view in the plan A-A depicted in FIG. 1;

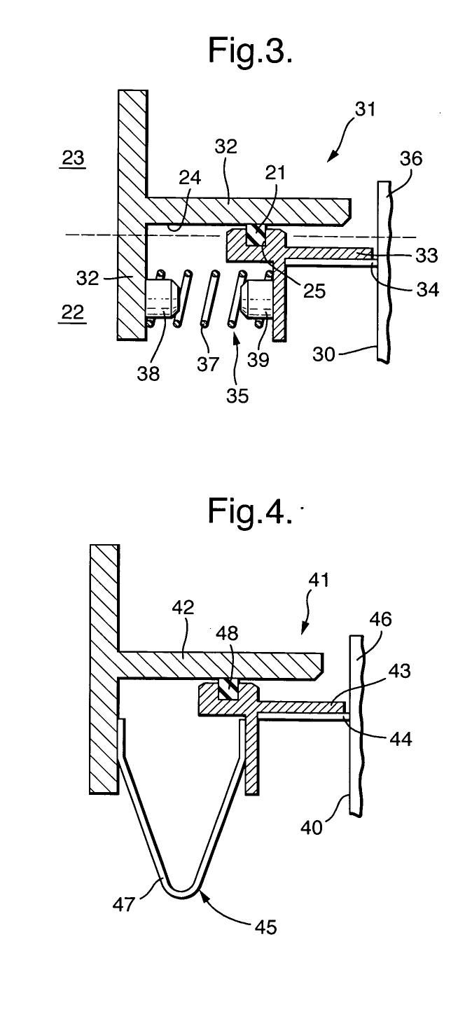

FIG. 3 is a schematic side illustration of a seal arrangement in accordance with a second embodiment of the present invention;

FIG. 4 is a schematic side illustration of a seal arrangement in accordance with a third embodiment of the present invention;

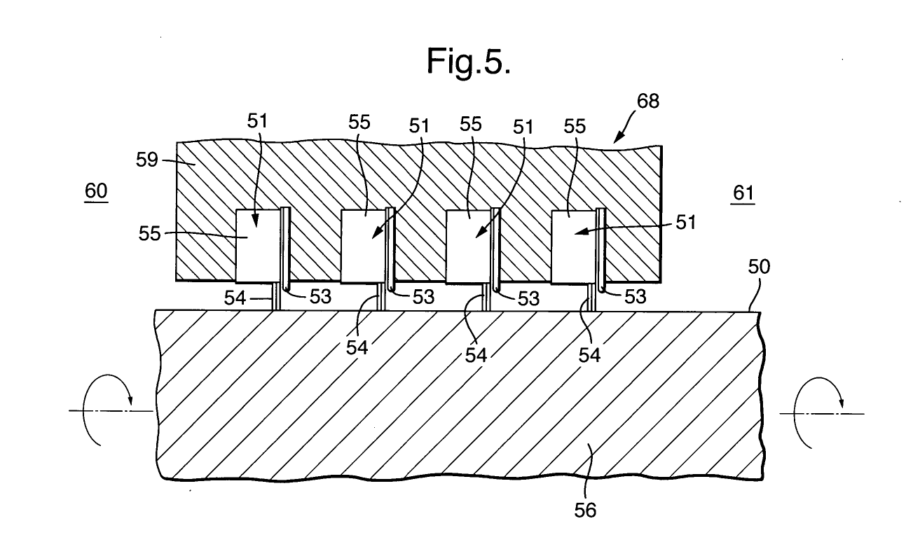

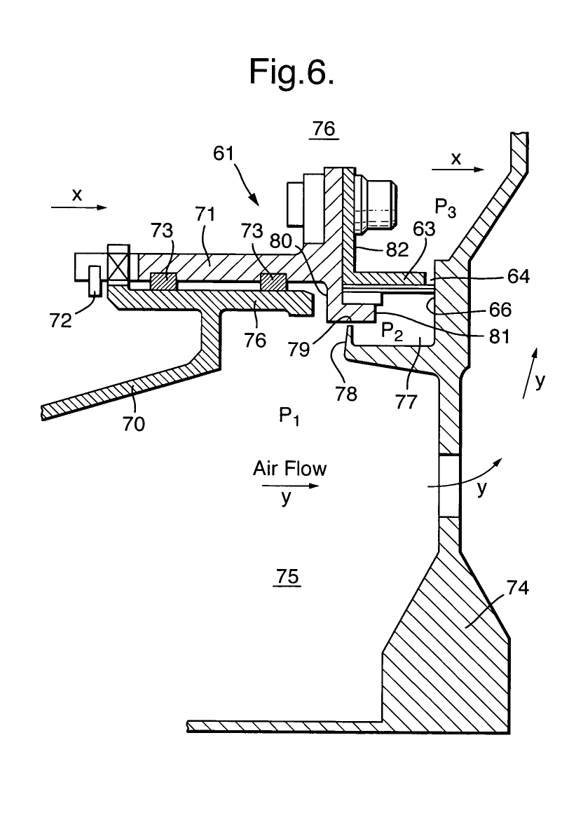

FIG. 5 is a schematic side view of a seal assembly in accordance with the present invention; and, FIG. 6 is a semi-schematic side view of a seal arrangement in accordance with a fourth embodiment of the present work.

Referring to FIG. 1 providing a schematic side illustration of a seal arrangement 1 in accordance with a first embodiment of the present invention. The arrangement 1 comprises a housing 2 within which a backing member 3 is located with an associated seal edge 4. The backing member 3 is secured upon the end of a bellows type concertina mounting 5 which acts to suspend the backing member 3 and therefore the seal edge 4.

The seal edge 4 is generally formed by a brush whereby the bristles and in particular the tips of those bristles create the seal edge 4. However, a seal edge could be alternatively made by an apron of elastomeric or other suitable material arranged in order to provide a seal.

The suspension mounting formed by the bellows mounting 5 allows axial movement in the direction of arrowheads B. Thus, as the seal edge 4 normally engages a component, shown by broken line 6, any excursions by that component 6 will be accommodated by movement of the mounting 5. In such circumstances, the seal edge 4 is arranged to extend beyond the backing member 3 towards the component 6. The extent by which the seal edge 4 extends beyond the backing member 3 will generally determine the efficiency of the seal in terms of leakage. Thus, in accordance with the present invention projection of this seal edge 4 can be set for a particularly operational situation and the extent of projection retained or protected against wear by the suspension effect of the mounting 5. In short, the seal edge 4 floats on the mounting 5 and axial movements of the component 6 can be compensated for whilst maintaining an effective seal.

As indicated above, the efficiency of a seal is for the most part dependent upon control of the backing member 3 to component 6 clearance distance as this determines the extent by which the seal edge 4 must extend to provide the seal. In accordance with the present invention this clearance is set upon installation and axial movement accommodated by the mounting 5, in this first embodiment by a bellows like combination.

The bristles of a brush to form the seal edge 4 are generally attached perpendicularly to the component 6 surface. The bristles are set at an angle to the component centreline, when a rotor, such that these bristles trail with respect to the direction of rotation (see FIG. 2). Thus, the bristles by bunching and through their tips forming the seal edge create an effective seal between the component 6 and a component (not shown) within which the housing 2 is secured.

Normally as indicated above the component 6 will be a rotor. Thus, the seal edge 4 will extend as a ring about the rotor component 6. Similarly, the backing member 3 is a ring whose inner diameter 7 is machined or otherwise specified to achieve a small clearance relative to the component 6. The backing member 3 is secured usually by welding to an end 8 of the mounting 5. This mounting 5 in the first embodiment depicted in FIG. 1 and FIG. 2 is a bellows type concertina combination in order to generate a seal bias force presenting the seal edge 4 to the component 6. Again, generally the concertina combination is selected in terms of its mean diameter, that is to say the natural expansion state of the combination 5, in order that there is a balance in the bias forces presented through the seal edge 4. The opposite end of the combination is secured to the housing again normally through appropriate welding. In such circumstances the bellows combination 5 itself provides a seal barrier from one side 9 to the other side 10 of the arrangement 1. Thus, the bellows combination 5 provides a secondary seal with in the arrangement 1.

The bellows combination 5 as depicted in FIG. 1 comprises a number of leaves 11 secured about their ends so that the leaves 11 can pivot relative to each other. By such action the combination 5 can expand and contract to accommodate the necessary displacement of the seal edge 4 whilst still providing a secondary seal between the housing 2 and the backing member 3/seal edge 4.

FIG. 2 shows a schematic view in the direction marked by arrowhead A depicted in FIG. 1. A discussed previously, the seal edge 4 is formed from bristles 12 of a brush. These bristles 12 are presented at an angle 13 so that they extend away in the direction of rotation of the component 6. Thus, an effective seal is formed despite rotation of the component 6.

FIG. 3 provides a schematic side illustration of a seal arrangement 31 in accordance with a second embodiment of the present invention. The principle of operation of the arrangement 31 is substantially the same as that described with regard to the first embodiment depicted in FIGS. 1 and 2. Thus, a housing 32 is associated with a backing member 33 and a seal edge 34. The edge 34 is presented upon a suspension mounting 35 towards a rotor 36 and a seal formed with the face 30.

The suspension mounting 35 comprises a coil spring 37 secured between a housing stay 38 and a backing member stay 39 in order to present the edge 34. As the spring 37 is open and so does not present a seal barrier a specific secondary seal ring 21 is provided. Thus, the seal 21 acts in cooperation with the seal edge 34 to create a seal barrier between one side 22 and the other side 23 of the arrangement 31.

The seal edge 34 as described previously extends beyond the backing member 33. Normally, the seal edge 34 is formed from bristles presented at an angle to the direction of rotation of the rotor component 36. In such circumstances, the backing member 33 is formed to provide a small clearance relative to the rotor face 30 and with a concentric wall surface 24 of the housing 32. A groove 25 is provided, normally by machining, in the backing member 33 within which the seal 21 is secured. Typically, this seal 21 is of a piston ring type extending as a band around the backing member 33 in order to provide an effective secondary seal to cooperate with the seal edge 34.

The spring 37 provides a seal bias force to urge the seal edge 34 towards the rotor face 30. The spring 37 will normally be arranged to be in at least slight compression in order to present the desired seal bias force against the face 30. The strength of the spring 37 will be chosen by operational requirements. It will be understood that the seal force should be sufficient to present an adequate seal but not too great to cause itself excessive wear of the seal edge 34. Normally, a number of small coil springs are located evenly and equally around the circumference of the housing 32 and backing member 33 so that the seal edge 34 is appropriately suspended to float with axial movements of the rotor component 36.

FIG. 4 is a schematic side illustration of a seal arrangement 41 in accordance with a third embodiment of the present invention. The arrangement is similar to that depicted in FIG. 3 but instead of a coil spring, a leaf spring 47 is provided.

The seal arrangement 41 as previously comprises a housing 42 with a backing member 43 and seal edge 44 presented to a rotor face 40 by a mounting comprising the leaf spring 47. The seal edge 44 extends beyond the backing member 43 and is suspended on a mounting 45 formed by the spring 47. Thus, axial excursions by a rotor 46 can be accommodated.

In order to appropriately present the edge 44 a number of springs 47 are provided at equal and even spacing between the housing 42 and the backing member 43. However, the springs 47 do not form a barrier so that a secondary seal 48 is provided in a groove formed in the backing member 43. Nevertheless, assembly of leaf springs 47 in a seal arrangement 41 should be simpler than with the suspension mountings in the other arrangements 1, 31 described previously.

The suspension mountings provided by all bellows combination or springs described above all allow axial movement of their respective seal edge whilst lateral movement along the component is prevented by the backing member. Thus, the present seal arrangements provide a relatively robust seal but nevertheless there will be a degree of leakage. In such circumstances, a cascade of seal arrangements in series along the rotating component are normally provided as depicted in schematic side illustration of FIG. 5.

In FIG. 5 seal arrangements 51 are positioned relative a rotor component 56 in order that a seal edge 54 provides a seal with a face surface 50. The seal arrangements 51 are secured in another component 59 which tends to be stationary. Each seal arrangement 51 includes a suspension mounting 55 and a backing member 53 to ensure appropriate presentation of the bristles which form the seal edge 54. The suspension mountings 55 allow for axial movement of each seal edge 54 in response to excursions by the rotor 56 whilst each backing member 53 resist lateral shift of the seal edges 54 when subjected to excessive pressure from one side 60 to the other side 61 of the seal arrangement 51.

The seal arrangements 51 act in concert to provide an effective seal barrier. As indicated above each respective seal arrangement 51 will leak to a certain extent. Thus, by providing a series cascade of arrangements 51 these leakage effects can be diminished to acceptable levels. The cascade of arrangements 51 creates a labyrinthine seal assembly which achieves the desired level of sealing efficiency. However, it will be appreciated that a cascade of seal arrangements will generally require sufficient space and gaps between respective arrangements to be effective.

As can be seen in the drawings generally the suspension mountings will be relatively free. In such circumstances, it may be necessary to provide a stop member to protect the mounting and other components from shock or other lateral forces presented to the arrangement. A stop member may take the form of an end 8 which includes a protruding foot part to engage the housing or a stop member may be the secondary seal 31, 48 where the greater the excessive pressure the more forceful the secondary seal.

Normally, the seal bias force created by the suspension mounting will be of relatively low strength as described previously in order not to cause itself excessive wear of the seal edge. However, it may be possible to specifically vary the seal force presented where required. For example, the pressure within the bellows combination could be increased or decreased to alter the bias force provided and so seal force presented through the seal edge. In such circumstance the bellows combination would act like a pneumatic or hydraulic spray. Alternatively, the stays used with a coil spring or a leaf spring may be adjusted to change the compression response of that spring and so seal force presented.

FIG. 6 illustrates a side view of a seal arrangement in accordance with a fourth embodiment with the present invention. Thus a backing member 63 presents a seal edge 64 to a sealing surface 66 in order to provide a seal. A static structure 70 supports a sliding element 71 to which the backing member 63 is associated. The sliding element 71 is arranged to allow axial movement in the direction of arrow heads X to allow the packing member 63 and sealing edge 64 to traverse into appropriate engagement with the sealing surface 66. The sliding element 71 incorporates a back stop 72 to prevent clash between the backing member 63 and the sealing surface 66 as a result of excessive displacement. Auxiliary or secondary air seals 73 are provided in order to present a seal between the static structure 70 and the slide element 71.

The sealing surface 66 is presented on a rotating element 74 with an air flow in the direction of arrow heads Y. The purpose of the seal arrangements 61 is to present a seal between the enclosure 75 created by the static structure 70 and rotating element 74 and the exterior 76. Generally, the enclosure 75 will be at a gas pressure of P1 whilst the exterior 76 will be at a gas pressure of P3. Clearly, the gas is usually air.

In accordance with the fourth embodiment of the present invention depicted in FIG. 6, the combination of sliding element 71 and backer member 63 with sealing edge 64 is suspended along the slide path created by a slide flange 76 of the static structure 70. Such suspension is achieved through pressure differentials between P1 and P3 along with variation in gas pressure P2 in a suspension cavity 77.

It will be understood that generally the static structure 70 and rotating member 74 are part of a turbine engine. Thus, when that engine is shut down or non-operational all the pressures P1, P2, P3 are equalised at ambient pressure and so the sealing edge 64 is not stressed. Upon starting of the engine, the rotating element 74 generates a rapid increase in pressure P1 and this causes pressure P1 to be significantly higher than pressure P2 in the cavity 77. In such circumstances, the pressure differential between pressure P1 and pressure P2 causes the sliding element 71 to move whereby the sealing edge 64 is brought into contact with the sealing surface 66 to create a seal between them.

The cavity 77 is configured with a seal fin 78 adjacent a part 79 of the slide element 71 combination. There is a clearance gap between this fin 78 and the part 79 through which there is gas leakage such that gradually pressure P2 increases towards enclosure pressure P1. This increase in pressure P2 reduces the pressure differential presented to the slide element 71 combination which in turn reduces the presented force through the seal edge 64 upon the sealing surface 66. However, if that force is insufficient such that there is leakage across the sealing edge 64 or there is a sudden relative movement between the rotating element 74 and the slide element 71 combination then the suspension cavity 77 pressure P2 will either gradually or suddenly decay towards the exterior pressure P3. In such circumstances, there will again be a greater pressure differential between the enclosure pressure P1 and pressure P2 now approximating exterior pressure P3. This pressure differential will again present force through the slide element 71 combination to bring the seal element 64 into engagement with the seal surface 66 in order to re-establish an adequate seal.

Generally, there will be an initial relatively high force presented through the slide element 71 combination to present the seal edge 64 to the sealing surface 66 but gradually this pressure will be reduced until equilibrium is established between the gas pressures P1, P2, P3 whereby the presentation force through the seal edge 64 is just sufficient to maintain an adequate seal barrier as required. In such circumstances, the seal edge 64 is not overly stressed and therefore should wear more slowly with a longer operational life.

Suspension of the slide element 71 combination is achieved by policing the pressures P1, P2, P3 and the effective areas upon which these presses P1, P2, P3 act. It will be understood that the cavity 75 is confined by the seals 73 such that pressure is presented against surfaces such as 80 in order to force slide movement in the direction of arrow heads X. However, this slide movement in the direction of arrow heads X is balanced by the force presented by the pressures P2, P3 against respective surfaces 81, 82 such that the slide element 71 combination including backing member 63 and seal edge 64 is suspended along the slide surface 76 of the static structure 70.

It will be appreciated that the clearance between fin 78 and the surface of part 79 may be configured in order to provide varying clearance and therefore leakage to equalise pressures P1, P2 dependent upon actual position. Thus, rather than being flat, they may be shaped or sloped to varying leakage and therefore suspension response as a result of pressure differentials between P1, P2 and P3.

Rather than simply depend upon pressure differentials, it will be appreciated that although not shown a bias compression spring or other device could be used in order to provide at least a minimum sealing pressure through the sealing edge 64 upon the sealing surface 66.

Seal arrangements in accordance with the present invention along with seal assemblies incorporating these arrangements have particular use in turbine engines. For example, there are a number of locations within such engines where a rotary shaft must be sealed relative to a stationary housing. The present invention allows provision of such a seal with less likelihood of premature wear and better control of the seal edge for improved sealing efficiency.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. A seal arrangement for a rotating component, the arrangement comprising a seal edge with a backing member to provide a seal in use, the seal edge extending beyond the backing member, the arrangement characterised in that the seal edge is suspended upon a suspension mounting to control the extent by which the seal edge extends beyond the backing member.

2. An arrangement as claimed in claim 1 wherein the seal edge is provided by bristle tips from a seal brush.

3. An arrangement as claimed in claim 2 wherein the brush comprises bristles angled relative to the seal edge.

4. An arrangement as claimed in claim 1 wherein the seal edge is provided by a seal apron of elastomeric material.

5. An arrangement as claimed in claim 1 wherein the suspension mounting comprises a bellows like concertina arrangement.

6. An arrangement as claimed in claim 1 wherein the suspension mounting comprises a compression spring.

7. An arrangement as claimed in claim 1 wherein the suspension mounting comprises a leaf spring.

8. An arrangement as claimed in claim 1 wherein the suspension mounting comprises one of a hydraulic and a pneumatic spring.

9. An arrangement as claimed in claim 1 wherein the seal edge is secured about an end of the suspension mounting.

10. An arrangement as claimed in claim 1 wherein the suspension mounting provides a seal bias force for the seal edge.

11. An arrangement as claimed in claim 10 wherein the seal force bias is altered to provide differing seal strengths for the seal arrangement.

12. An arrangement as claimed in claim 1 wherein a stop member is provided in association with one of the backing member and the suspension mounting to prevent lateral displacement of the arrangement.

13. An arrangement as claimed in claim 1 wherein a secondary seal is provided to supplement the seal provide by the seal edge.

14. An arrangement as claimed in claim 13 wherein the secondary seal is associated with the backing member.

15. An arrangement as claimed in claim 13 wherein the secondary seal is a compression ring between the backing member and a housing within which the arrangement is secured.

16. An arrangement as claimed in claim 11 wherein the secondary seal is part of the member.

17. A seal as claimed in claim 1 wherein a slide element presents a backing member towards a sealing surface with the sealing edge towards the sealing surface, the slide element is suspended through variations in pressure differential between an enclosure pressure P1 and a seal cavity pressure P2 as varied by leakage across the sealing edge towards an exterior pressure P3.

18. An arrangement as claimed in claim 17 wherein the slide element is supported upon a slide surface with secondary seals there between.

19. An arrangement as claimed in claim 17 wherein the slide element is constrained to axial movement in order to present the seal edge similarly.

20. An arrangement as claimed in claim 19 wherein axial movement is limited by a stop element to prevent clash between the backing member and the seal surface.

21. An arrangement as claimed in claim 17 wherein the seal cavity pressure P2 is defined within a seal cavity configured by a seal fin adjacent a part of the slide element.

22. An arrangement as claimed in claim 21 wherein one of the seal fin and the part are shaped to provide variation of a clearance gap between that fin and part dependent upon actual position of the slide element.
